(19) United States
(12) Patent Application Publication
(10) Pub. No.: US 2021/0252404 A1
(43) Pub. Date: Aug. 19, 2021

(54) COMPUTER-READABLE RECORDING MEDIUM, GAME SYSTEM, AND METHOD FOR GAME CONTROL

(71) Applicant: SQUARE ENIX CO., LTD., Tokyo (JP)

(72) Inventors: Tsuyoshi YOKOZAWA, Tokyo (JP); Yuu IKEMOTO, Tokyo (JP)

(73) Assignee: SQUARE ENIX CO., LTD., Tokyo (JP)

(21) Appl. No.: 17/157,791

(22) Filed: Jan. 25, 2021

(30) Foreign Application Priority Data
Jan. 29, 2020 (JP) 2020-012881

(51) Int. Cl. A63F 13/69; A63F 13/35

(52) U.S. Cl. CPC A63F 13/69; A63F 13/35

(57) ABSTRACT

Non-transitory computer-readable recording mediums having stored thereon game programs, game methods, and game systems including one or more terminal apparatuses a server apparatus are disclosed. An example game system includes: one or more terminal apparatuses operated by a player; and a server apparatus that is configured to connect to the one or more terminal apparatuses by communication. The game system comprises one or more computers configured to perform functions comprising: creating a group including at least one character operated by the player; progressing an event for each created group; providing an object to the at least one character in the event based on a predetermined provision probability used for determining whether or not to provide the object; and calculating an evaluation of the group in the event based on the provided object. In an MMORPG, collection is performed as a group, and a collection result of the group is evaluated.

### CROSS REFERENCE TO RELATED APPLICATION(S)

The present disclosure claims priority to Japanese Patent Application No. 2020-012881, filed on Jan. 29, 2020, the disclosure of which is expressly incorporated herein by reference in its entirety for any purpose.

### BACKGROUND

The present disclosure relates to a computer-readable recording medium, a game system, and a method for game control.

In the related art, there is a game such as a massively multiplayer online role-playing game (MMORPG) in which multiple players can play at the same time in the same online game space. In addition, there is a game in which multiple people form a party and clear a mission in cooperation.

### SUMMARY

A purpose of at least one embodiment of the present disclosure is to provide a new computer-readable recording medium of higher interest.

According to a non-limiting aspect, a non-transitory computer-readable recording medium having recorded thereon a game program which is executed in a server apparatus of a game system including one or more terminal apparatuses operated by a player and the server apparatus connectable to the terminal apparatus by communication, the game program causing the server apparatus to function as: a group creator that creates a group including at least one character operated by the player, an event progressor that progresses an event for each created group, an object provider that provides an object to the character in the event based on a predetermined provision probability, and an evaluation calculator that calculates an evaluation of the group in the event based on the provided object.

According to a non-limiting aspect, a game system including one or more terminal apparatuses operated by a player and a server apparatus connectable to the terminal apparatus by communication, the game system comprising: a group creator that creates a group including at least one character operated by the player, an event progressor that progresses an event for each created group, an object provider that provides an object to the character in the event based on a predetermined provision probability, and an evaluation calculator that calculates an evaluation of the group in the event based on the provided object.

According to a non-limiting aspect, a method for game control executed in a server apparatus of a game system including one or more terminal apparatuses operated by a player and the server apparatus connectable to the terminal apparatus by communication, the method including: creating a group including at least one character operated by the player, progressing an event for each created group, providing an object to the character in the event based on a predetermined provision probability, and calculating an evaluation of the group in the event based on the provided object.

### BRIEF DESCRIPTION OF THE DRAWINGS

FIG. 1 is a block diagram illustrating a configuration of the server apparatus according to at least one embodiment of the present disclosure.

FIG. 2 is a flowchart of the program execution process according to at least one embodiment of the present disclosure.

FIG. 3 is a block diagram illustrating a configuration of the server apparatus according to at least one embodiment of the present disclosure.

FIG. 4 is a flowchart of the program execution process according to at least one embodiment of the present disclosure.

FIG. 5 is a block diagram illustrating a configuration of the server apparatus according to at least one embodiment of the present disclosure.

FIG. 6 is a flowchart of the program execution process according to at least one embodiment of the present disclosure.

FIG. 7 is a block diagram illustrating a configuration of the system according to at least one embodiment of the present disclosure.

FIG. 8 is a block diagram illustrating a configuration of the system according to at least one embodiment of the present disclosure.

FIG. 9 is a flowchart related to an event participation permission determination according to at least one embodiment of the present disclosure.

FIG. 10 is a flowchart related to the event progress process according to at least one embodiment of the present disclosure.

FIGS. 11A to 11C are diagrams illustrating a provided object master table according to at least one embodiment of the present disclosure.

FIGS. 12A to 12C are diagrams illustrating an example of the provision probability at a time of the fever fishing mode according to at least one embodiment of the present disclosure.

FIGS. 13A to 13C are diagrams for describing an evaluation result according to at least one embodiment of the present disclosure.

FIG. 14 is a block diagram illustrating a configuration of the system according to at least one embodiment of the present disclosure.

FIG. 15 is a flowchart of the execution process according to at least one embodiment of the present disclosure.

FIG. 16 is a block diagram illustrating a configuration of the computer apparatus according to at least one embodiment of the present disclosure.

FIG. 17 is a flowchart of the program execution process according to at least one embodiment of the present disclosure.

FIG. 18 is a block diagram illustrating a configuration of the computer apparatus according to at least one embodiment of the present disclosure.

FIG. 19 is a flowchart of the program execution process according to at least one embodiment of the present disclosure.

### DESCRIPTION OF EMBODIMENTS

Hereinafter, embodiments of the disclosure will be described with reference to the accompanying drawings. Hereinafter, description relating to effects shows an aspect of the effects of the embodiments of the disclosure, and does not limit the effects. Further, the order of respective processes that form a flowchart described below may be changed in a range without contradicting or creating discord with the processing contents thereof.

### First Embodiment

A summary of a first embodiment of the present disclosure will be described. Hereinafter, a game program that is executed in a server apparatus of a game system including one or more terminal apparatuses operated by a player and the server apparatus connectable to the terminal apparatus by communication will be illustratively described as the first embodiment.

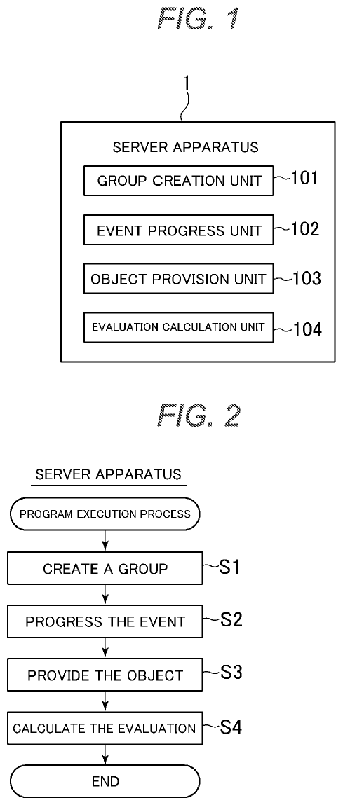

FIG. 1 is a block diagram illustrating a configuration of the server apparatus according to at least one embodiment of the present disclosure. A server apparatus 1 includes at least a group creation unit 101, an event progress unit 102, an object provision unit 103, and an evaluation calculation unit 104.

The group creation unit 101 has a function of creating a group that includes at least one character operated by the player. The event progress unit 102 has a function of progressing an event for each created group.

The object provision unit 103 has a function of providing an object to the character in the event based on a predetermined provision probability. The evaluation calculation unit 104 has a function of calculating an evaluation of the group in the event based on the object provided by the object provision unit 103.

Next, a program execution process in the first embodiment of the present disclosure will be described. FIG. 2 is a flowchart of the program execution process according to at least one embodiment of the present disclosure.

The server apparatus 1 creates the group including at least one character operated by the player (step S1). Next, the server apparatus 1 progresses the event for each created group (step S2). Next, the server apparatus 1 provides the object to the character in the event based on the predetermined provision probability (step S3). Next, the server apparatus 1 calculates the evaluation of the group in the event based on the provided object (step S4) and finishes the process.

As one aspect of the first embodiment, a new game program of higher interest can be provided.

In the first embodiment, for example, the “terminal apparatus” refers to a stationary game console, a portable game console, a wearable terminal, a desktop or laptop personal computer, a tablet computer, or a PDA and may be a portable terminal such as a smartphone that includes a touch panel sensor on a display screen. For example, the “server apparatus” refers to an apparatus that executes a process in accordance with a request from the terminal apparatus.

For example, the “group” refers to a group that includes at least one character operated by the player. For example, the “event” refers to a content of a part of a game. For example, the “provision probability” refers to a probability used for determining whether or not to provide the object. For example, the “evaluation” refers to an index indicating values of the group and the character in the event. For example, the “calculation” refers to derivation of a value in accordance with a predetermined rule and, more specifically, is illustrated by addition, subtraction, multiplication, and division of quantities, calculation of points corresponding to an attribute of the object, and the like.

### Second Embodiment

Next, a summary of a second embodiment of the present disclosure will be described. Hereinafter, a game program that is executed in a server apparatus of a game system including one or more terminal apparatuses operated by a player and the server apparatus connectable to the terminal apparatus by communication will be illustratively described as the second embodiment.

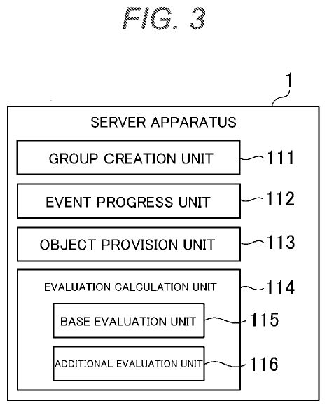

FIG. 3 is a block diagram illustrating a configuration of the server apparatus according to at least one embodiment of the present disclosure. The server apparatus 1 includes at least a group creation unit 111, an event progress unit 112, an object provision unit 113, and an evaluation calculation unit 114. The evaluation calculation unit 114 includes a base evaluation unit 115 and an additional evaluation unit 116.

The group creation unit 111 has a function of creating a group that includes at least one character operated by the player. The event progress unit 112 has a function of progressing an event for each created group.

The object provision unit 113 has a function of providing an object to the character in the event based on a predetermined provision probability. The evaluation calculation unit 114 has a function of calculating an evaluation of the group in the event based on the object provided by the object provision unit 113.

The base evaluation unit 115 has a function of deciding a base evaluation based on an attribute of the object. The additional evaluation unit 116 has a function of deciding an additional evaluation corresponding to a satisfied addition condition in a case where a predetermined addition condition is satisfied.

The evaluation calculation unit 114 preferably calculates the evaluation of the group based on the base evaluation and the additional evaluation.

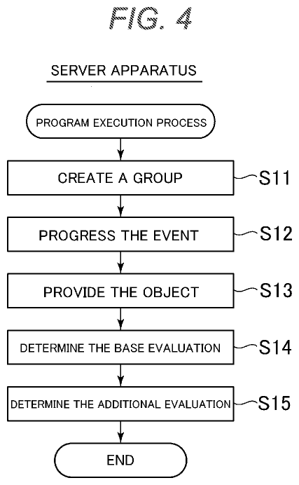

Next, a program execution process in the second embodiment of the present disclosure will be described. FIG. 4 is a flowchart of the program execution process according to at least one embodiment of the present disclosure.

The server apparatus 1 creates the group including at least one character operated by the player (step S11). Next, the server apparatus 1 progresses the event for each created group (step S12). Next, the server apparatus 1 provides the object to the character in the event based on the predetermined provision probability (step S13). Next, the server apparatus 1 determines the base evaluation based on the attribute of the object (step S14). Next, in a case where the predetermined addition condition is satisfied, the server apparatus 1 determines the additional evaluation corresponding to the satisfied addition condition (step S15) and finishes the process.

As one aspect of the second embodiment, a new program of higher interest can be provided.

As one aspect of the second embodiment, a new program of higher interest that motivates the player to satisfy the addition condition by adding the evaluation corresponding to the satisfied addition condition in a case where the addition condition is satisfied can be provided.

In the second embodiment, each of the “terminal apparatus”, the “server apparatus”, the “group”, the “event”, the “provision probability”, the “evaluation”, and the “calculation” can employ contents disclosed in the first embodiment as necessary.

In the second embodiment, for example, the “attribute” refers to information for representing a state of the object. More specifically, the attribute is illustrated by quality, rarity, rank, size, taste, and the like. For example, the “base evaluation” refers to information that is a base of the evaluation. For example, the “addition condition” refers to a condition for further adding an evaluation to the base evaluation. For example, the “additional evaluation” refers to the evaluation to be added.

### Third Embodiment

Next, a summary of a third embodiment of the present disclosure will be described. Hereinafter, a game program that is executed in a server apparatus of a game system including one or more terminal apparatuses operated by a player and the server apparatus connectable to the terminal apparatus by communication will be illustratively described as the third embodiment.

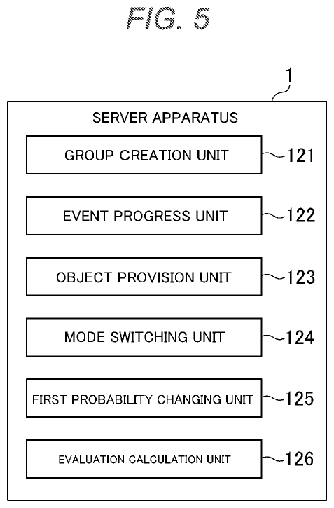

FIG. 5 is a block diagram illustrating a configuration of the server apparatus according to at least one embodiment of the present disclosure. The server apparatus 1 includes at least a group creation unit 121, an event progress unit 122, an object provision unit 123, a mode switching unit 124, a first probability changing unit 125, and an evaluation calculation unit 126.

The group creation unit 121 has a function of creating a group that includes at least one character operated by the player. The event progress unit 122 has a function of progressing an event for each created group.

The event progress unit 122 preferably progresses the event in one or more stages.

The object provision unit 123 has a function of providing an object to the character in the event based on a predetermined provision probability. The mode switching unit 124 has a function of switching a mode of the stage in a case where a predetermined switching condition is satisfied. The first probability changing unit 125 has a function of changing the predetermined provision probability in a case where the mode is switched.

The evaluation calculation unit 126 has a function of calculating an evaluation of the group in the event based on the object provided by the object provision unit 123.

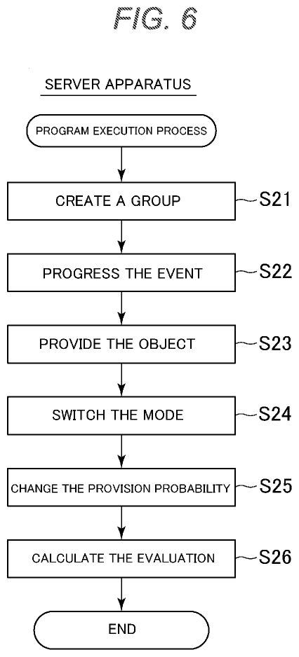

Next, a program execution process in the third embodiment of the present disclosure will be described. FIG. 6 is a flowchart of the program execution process according to at least one embodiment of the present disclosure.

The server apparatus 1 creates the group including at least one character operated by the player (step S21). Next, the server apparatus 1 progresses the event for each created group (step S22). The event progresses in one or more stages.

Next, the server apparatus 1 provides the object to the character in the event based on the predetermined provision probability (step S23). Next, the server apparatus 1 switches the mode of the stage in a case where the predetermined switching condition is satisfied (step S24). Next, the server apparatus 1 changes the predetermined provision probability in a case where the mode is switched (step S25). Next, the server apparatus 1 calculates the evaluation of the group in the event based on the provided object (step S26) and finishes the process.

As one aspect of the third embodiment, a new program of higher interest can be provided.

As one aspect of the third embodiment, a new program of higher interest that motivates the player to switch the mode by switching the mode of the stage and changing the provision probability of the object in a case where the predetermined switching condition is satisfied can be provided.

In the third embodiment, each of the “terminal apparatus”, the “server apparatus”, the “group”, the “event”, the “provision probability”, the “evaluation”, and the “calculation” can employ the contents disclosed in the first embodiment as necessary.

In the third embodiment, for example, a part or the entirety of the event is configured with the “stage”. For example, the “mode” refers to a collection of functions for specifying a state of the game. More specifically, the mode is defined by setting a parameter of setting and a usable function in advance. In a case where a plurality of modes are present, availability of switching can be set.

### Fourth Embodiment

Next, a summary of a fourth embodiment of the present disclosure will be described. Hereinafter, a game system including one or more terminal apparatuses operated by a player and a server apparatus connectable to the terminal apparatus by communication will be illustratively described as the fourth embodiment.

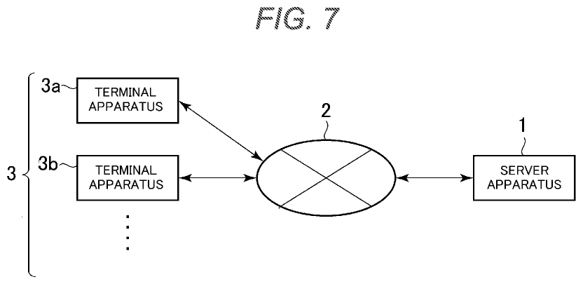

FIG. 7 is a block diagram illustrating a configuration of the system according to at least one embodiment of the present disclosure. As illustrated, the system is configured with a plurality of terminal apparatuses 3 (terminal apparatuses 3a, 3b, . . . ) operated by a plurality of users (users A, B, . . . ), a communication network 2, and the server apparatus 1. The terminal apparatuses 3 are connected to the server apparatus 1 through the communication network 2. The terminal apparatuses 3 and the server apparatus 1 may not be connected at all times, and connection may be available as necessary.

The server apparatus 1 includes at least a control unit, a RAM, a storage unit, and a communication interface that are connected to each other through an internal bus. The control unit may include an internal timer. In addition, the control unit may synchronize with an external server by the communication interface. Accordingly, a real time may be acquired.

For example, each terminal apparatus 3 includes a control unit, a RAM, a storage unit, a sound processing unit, a graphics processing unit, a communication interface, and an interface unit that are connected to each other through an internal bus. The graphics processing unit is connected to a display unit. The display unit may include a display screen and a touch input unit that receives an input by contact of the player with the display unit.

For example, the touch input unit may detect a position of contact using any method of a resistive film method, an electrostatic capacitance method, an ultrasonic surface acoustic wave method, an optical method, or an electromagnetic induction method used in a touch panel. Any method may be used provided that an operation performed by a touch operation of the user can be recognized. The touch input unit is a device that can detect a position of a finger or the like in a case where an operation such as a push or movement is performed on an upper surface of the touch input unit by a finger, a stylus, or the like.

An external memory (for example, an SD card) may be connected to the interface unit. Data read from the external memory is loaded into the RAM and is subjected to a calculation process executed by the control unit.

The communication interface can be connected to the communication network in a wireless or wired manner and can receive data through the communication network. The data received through the communication interface is loaded into the RAM and is subjected to the calculation process performed by the control unit in the same manner as the data read from the external memory.

Each terminal apparatus 3 may include a sensor such as a proximity sensor, an infrared sensor, a gyro sensor, or an acceleration sensor. In addition, each terminal apparatus 3 may include an imaging unit that has a lens and performs imaging through the lens. Furthermore, each terminal apparatus 3 may be a terminal apparatus that can be mounted (wearable) on a body.

### Summary of System

Next, a summary of the system assumed in the fourth embodiment of the present disclosure will be described. In the fourth embodiment, a game system (hereinafter, referred to as the system) that is related to an MMORPG and includes one or more terminal apparatuses operated by a player and a server apparatus connectable to the terminal apparatus by communication will be illustrated. For example, an event that is one event during a game for collecting an item in the game by forming a group (party) with another character is assumed. The item may be a medicinal plant, ore, fish, or other objects. In the event, an individual collection record and a group collection record may be evaluated.

A start time may be set for the event. A time set in the server apparatus 1 may be used as the start time. The time set in the server apparatus 1 may be synchronized with a standard time of an external server corresponding to a region of the player. That is, the start time may synchronize with a real world time corresponding to the region of the player and may be approximately the same time as the real world time. Alternatively, an in-game time that is different from the real world time may be set in the server apparatus 1.

Item collection is executed by moving the character operated by the user to a predetermined position and providing an operation instruction. Hereinafter, fishing will be illustratively described in the fourth embodiment of the present disclosure.

The user moves the character to a position for catching fish, selects a fishing pole and bait to be used, and performs casting. In a case where a predetermined time period elapses, random selection is performed based on the predetermined provision probability, and the server apparatus determines caught fish. The character catches the fish by performing a fighting motion until the fish is caught.

A fishing event may be performed at a predetermined location or may be performed during cruising by boarding a dedicated ship. Hereinafter, the fishing event performed by boarding the ship will be illustratively described.

The ship can move along a specific sea route. The ship may move by an operation of the player or may automatically move along a predetermined sea route. Hereinafter, a plurality of sea routes passing through spots appropriate for fishing will be set in advance, and the player will select any sea route.

An attribute such as a type, a grade, or quality may be set for the fish to be caught. An evaluation changes in accordance with the attribute.

### Functional Description

Functions of a system 4 will be described. FIG. 8 is a block diagram illustrating a configuration of the system according to at least one embodiment of the present disclosure.

The system 4 may include an environment determination unit 201, a group creation unit 202, an event progress unit 203, an object provision unit 204, a mode switching unit 205, a first probability changing unit 206, a second probability changing unit 207, an evaluation calculation unit 208, and a reward provision unit 209. The group creation unit 202 may include a participation permission determination unit 211. The evaluation calculation unit 208 may include a base evaluation unit 212 and an additional evaluation unit 213.

The environment determination unit 201 has a function of determining an environment of a stage included in the event based on a predetermined environment decision probability. The group creation unit 202 has a function of creating a group that includes at least one character operated by the player. The event progress unit 203 has a function of progressing the event for each created group.

The object provision unit 204 has a function of providing an object to the character in the event based on the predetermined provision probability. The mode switching unit 205 has a function of switching a mode of the stage in a case where a predetermined switching condition is satisfied.

The first probability changing unit 206 has a function of changing the predetermined provision probability for providing the object in a case where the mode is switched by the mode switching unit 205. The second probability changing unit 207 has a function of changing the predetermined provision probability based on an attribute of the character.

The evaluation calculation unit 208 has a function of calculating an evaluation of the group in the event based on the object provided by the object provision unit 204. The reward provision unit 209 has a function of providing a reward based on the evaluation calculated by the evaluation calculation unit 208.

The participation permission determination unit 211 has a function of determining permission of participation depending on whether or not a predetermined participation condition for participating in the event is satisfied. The base evaluation unit 212 has a function of deciding a base evaluation based on the attribute of the object. The additional evaluation unit 213 has a function of deciding an additional evaluation corresponding to a satisfied addition condition in a case where a predetermined addition condition is satisfied.

### Participation Process for Event

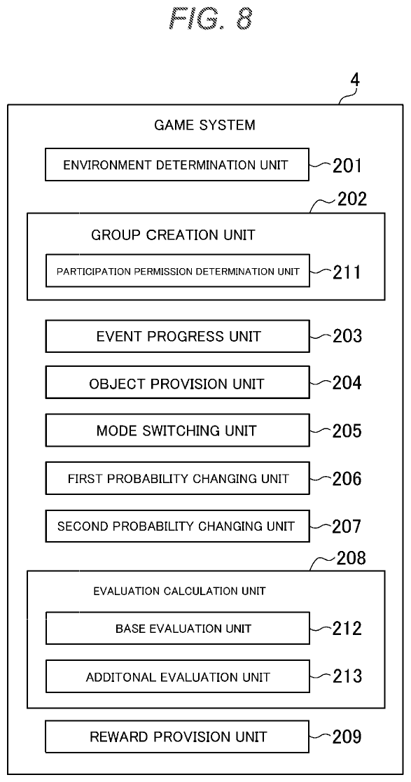

Next, a determination process related to the permission of participation in the event will be described using a flowchart. FIG. 9 is a flowchart related to an event participation permission determination according to at least one embodiment of the present disclosure.

Each terminal apparatus 3 receives a participation application made by an operation of the player (step S101). For example, the participation application is implemented by making a request to a non-player character (NPC) or using an item, points, or the like for participating in the event. Next, each terminal apparatus 3 transmits received information to the server apparatus 1 (step S102). For example, the received information includes information (character ID or the like) with which a player character can be specified.

The server apparatus 1 receives the transmitted information (step S103). Next, the server apparatus 1 acquires the real time (step S104). Here, a time may be acquired by synchronizing with the real time as necessary, or the time set in the server apparatus 1 may be acquired and set as the real time in synchronization with a predetermined timing.

Next, the server apparatus 1 determines whether or not a time range in which participation in the event is possible is reached (step S105). The time range in which participation is possible is set in accordance with a predetermined start time. For example, in a case where the start time of the event is set at a predetermined interval such as 03:00, 06:00, 09:00, 12:00, 15:00, 18:00, and 21:00 (24-hour notation), an application acceptance time range may be set from 30 minutes before each start time to each start time as the time range in which participation is possible.

In a case where the time range in which participation in the event is possible is reached (YES in step S105), the server apparatus 1 determines whether or not a character making the participation application for the event has participation qualification for the event (step S106). For example, the participation qualification is illustrated by reaching of a predetermined level by the character, reaching of a predetermined progress status of the game by the character, and possession of a predetermined skill or item by the character, but is not limited thereto.

In a case where the character has the participation qualification (YES in step S106), the server apparatus 1 determines that the character making the participation application in step S101 can participate, and accepts participation (step S107). In a case where the time range in which participation is possible is not reached (NO in step S105) or in a case where the character does not have the participation qualification (NO in step S106), the server apparatus 1 determines that the character making the participation application in step S101 cannot participate, and rejects participation (step S108).

Next, each terminal apparatus 3 displays a result related to the participation application on a display apparatus (step S109). Next, the server apparatus 1 creates a group to participate in the event by gathering characters that can participate (step S110), and finishes a participation permission determination process.

For example, the group may be created by gathering members of a guild formed before the event or randomly combining a plurality of characters received on the spot. The number of people who can participate in the event has an upper limit. In a case where the number of characters does not satisfy the upper limit, the event may be started with a smaller number of people than the upper limit, or the event may be started by adding NPCs to the upper limit.

### Event Progress Process

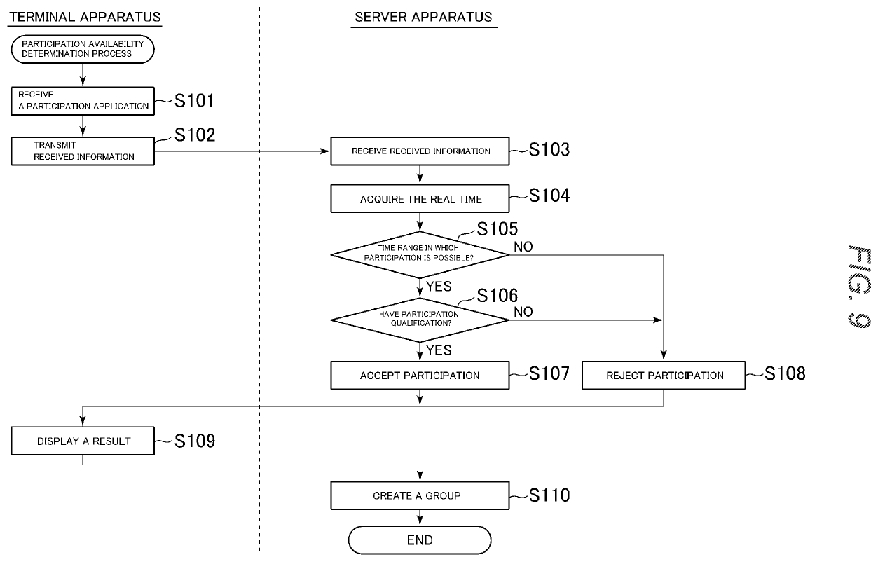

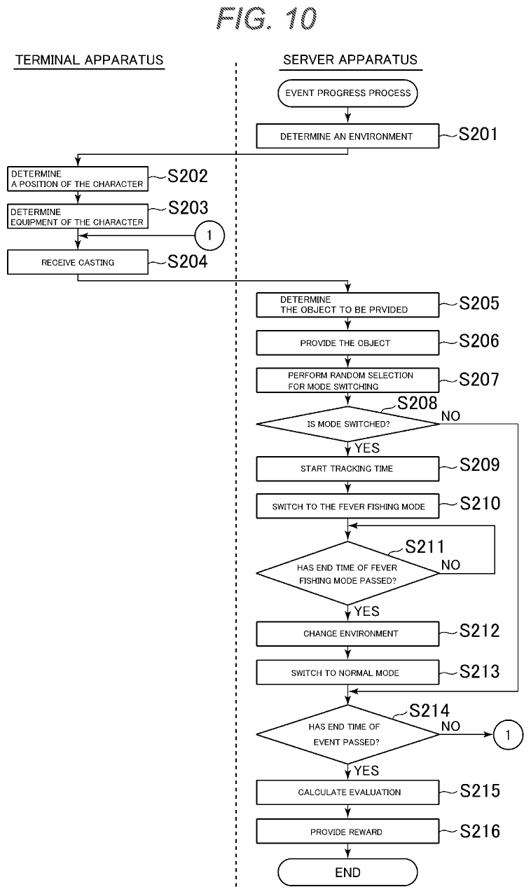

Next, an event progress process in the fourth embodiment of the present disclosure will be described. FIG. 10 is a flowchart related to the event progress process according to at least one embodiment of the present disclosure.

The server apparatus 1 starts the event in a case where the time set in the server apparatus 1 exceeds a predetermined event start time. The server apparatus 1 determines an environment of the event by random selection (step S201). For example, the environment of the event is illustrated by weather (sun, cloud, rain, snow, thunderstorm, and storm), a state of sea, presence or absence of wind, and a wind speed. Day and night setting may be set in connection with the start time of the event or may be set without connection with the start time such that the time in the event is night even in a case where the event starts at 09:00 in the morning.

The provision probability of the object described later may be changed in accordance with the environment of the event. For example, the provision probability may be changed in accordance with the weather. In addition, depending on the weather, the probability of the object that can be caught may be changed, or a target that can be caught may be changed such that fish of a high grade is caught. By randomly deciding the weather by random selection, a game system of higher interest that prevents the user from perceiving the weather in which the event is started, and causes the user to feel excitement can be provided.

Next, each terminal apparatus 3 determines a position of the character by the operation instruction from the user (step S202). As the position of the character, any location can be designated, or any of a plurality of predetermined positions may be selected.

Next, each terminal apparatus 3 determines equipment of the character by the operation instruction from the user (step S203). For example, the equipment of the character refers to a pole, a bait, a reel, and a lure to be used for fishing.

Next, each terminal apparatus 3 receives casting by the operation instruction from the user (step S204). After the predetermined time period elapses, the server apparatus 1 determines the object to be provided to the user by random selection (step S205). The character may be caused to execute the fighting motion during a period from casting until provision of the object.

### Provided Object Master Table

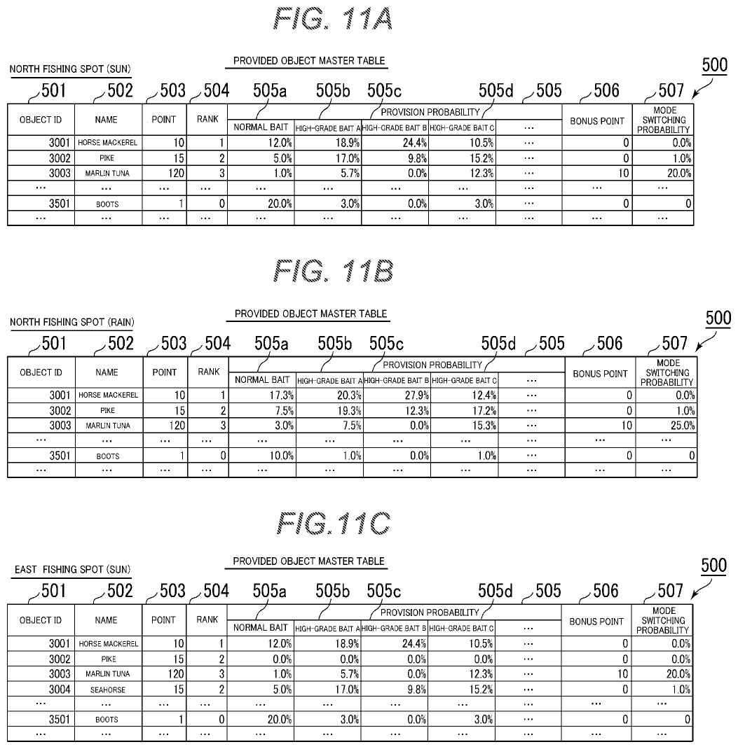

A master table of the object to be provided will be described. FIGS. 11A to 11C are diagrams illustrating a provided object master table according to at least one embodiment of the present disclosure. A provided object master table 500 may store a name 502, a point 503, a rank 504, a provision probability 505, a bonus point 506, and a mode switching probability 507 in association with an object ID 501. The provision probability 505 may be further divided into a normal bait 505a, a high-grade bait A 505b, a high-grade bait B 505c, and a high-grade bait C 505d in accordance with the bait to be used.

The point 503, the rank 504, and the bonus point 506 are information to be used for calculating the evaluation described later. The provision probability 505 is a probability set for each object. Random selection is performed based on the probability. In a case where the probability is 0%, it is indicated that the object cannot be caught at a fishing spot. The mode switching probability 507 illustrates a probability of switching to a fever fishing mode described later.

For example, FIG. 11A illustrates the provided object master table in a case where the weather is “sun” at a “north fishing spot”. For example, FIG. 11B illustrates the provided object master table in a case where the weather is “rain” at the “north fishing spot”. FIG. 11B is a case where the weather is different from FIG. 11A at the same fishing spot. As illustrated in FIG. 11B, the provision probability 505 and the mode switching probability 507 are changed by a difference in weather.

Meanwhile, for example, FIG. 11C illustrates the provided object master table in a case where the weather is “sun” at an “east fishing spot”. FIG. 11C is a case where the weather is the same at a different fishing spot from FIG. 11A. As illustrated in FIG. 11C, fish (object) that can be caught is changed by a difference in fishing spot. That is, the provision probability of providing the object is set in association with the fishing spot (the location or the stage).

The bait may change a probability of fish to be caught in accordance with an application of the bait. For example, in a case where a “bait for catching large fish” is used, a probability of catching fish of a large size can be set to be increased. In addition, a bait that causes fish of a specific type to be easily caught as in “deep sea fish catching” or “horse mackerel catching” may be used, and a bait from which a specific effect such as an “increase in probability of the fever fishing mode” can be expected may be used.

The flowchart will be referred to again. The server apparatus 1 provides the object determined in step S205 to the character (step S206). Providing the object to the character includes associating the object with an account of the user (player) operating the character.

Next, the server apparatus 1 executes random selection (step S207) as to whether or not to switch the mode based on the mode switching probability 507 associated with the object provided in step S206.

In a case where mode switching is executed (YES in step S208), the server apparatus 1 starts tracking time (step S209) and switches to the fever fishing mode (step S210).

### Fever Fishing Mode

For example, the fever fishing mode refers to a mode in which a likelihood of providing the object is higher than in a mode (hereinafter, referred to as a normal mode) before the fever fishing mode. A higher likelihood of providing refers to an increase in provision probability, a change in predetermined time period taken from casting until provision to one second while, for example, the predetermined time period is normally five seconds, enabling casting more number of times, doubling the number of objects to be provided, or a combination thereof. Consequently, an effect of increasing the evaluation described later is achieved.

In a case where the fever fishing mode is entered, the weather may be changed. For example, entrance may be visually recognizable by surrounding the ship with divine light. Furthermore, in a case where the fever fishing mode is entered, an operation of the character different from the normal mode may be executed. For example, the fighting motion during the period from casting until provision of the object may be changed to a motion dedicated to the fever fishing mode.

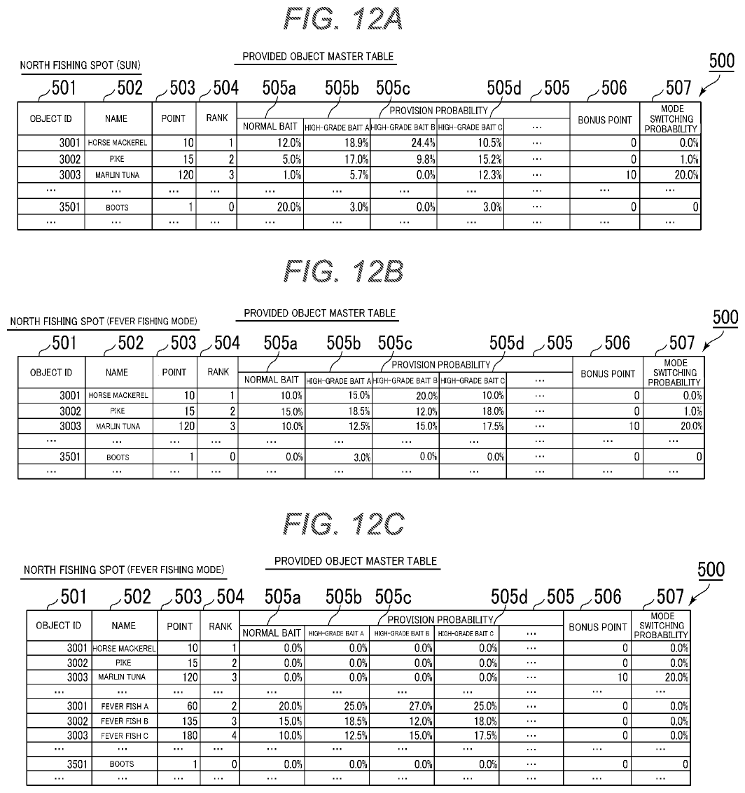

FIGS. 12A to 12C are diagrams illustrating an example of the provision probability at a time of the fever fishing mode according to at least one embodiment of the present disclosure. FIG. 12A is the provided object master table in the normal mode. Meanwhile, FIGS. 12B and 12C are the provided object master table in the fever fishing mode.

As illustrated in FIG. 12B, in a case where switching is performed to the fever fishing mode, the provision probability 505 of an object of a high rank (in the drawing, higher than or equal to rank 2) is increased, and the provision probability 505 of an object of a low rank (in the drawing, lower than or equal to rank 1) is decreased.

Alternatively, as illustrated in FIG. 12C, in a case where switching is performed to the fever fishing mode, fish of high points such as fever fishing fish A to C may be caught. The provision probability 505 of a part or all of fish caught in the normal mode is changed to 0%, and the provision probability 505 is changed such that substitute fish is caught.

An effect of the fever fishing mode is not limited to a player and a player character that confirm the fever fishing mode, and may be applied to all accompanying characters of the group. By doing so, a game system of higher interest in which the event can be enjoyed as a group can be provided.

The flowchart will be referred to again. A time limit to continue the fever fishing mode is set in advance. The server apparatus 1 determines whether or not an elapsed time period from a start of the fever fishing mode exceeds the time limit (step S211). In a case where the time limit is not exceeded (NO in step S211), the fever fishing mode is continued. In a case where the time limit is exceeded (YES in step S211), the fever fishing mode is finished, and the environment is changed such that the weather is set to sun (step S212). Furthermore, switching is performed to the normal mode (step S213).

Next, the server apparatus 1 determines whether or not a finish time of the event has passed (step S214). In a case where the finish time has not passed (NO in step S214), fishing can be continued. In a case where the finish time of the event has passed (YES in step S214), the server apparatus 1 calculates the evaluation (step S215).

In the event, a plurality of characters can play in parallel and may check a state of a fishing result with each other. By doing so, a game system of higher interest that can be enjoyed by both a player experienced in fishing and a so-called beginner player not experienced in fishing can be provided.

### Calculation of Evaluation

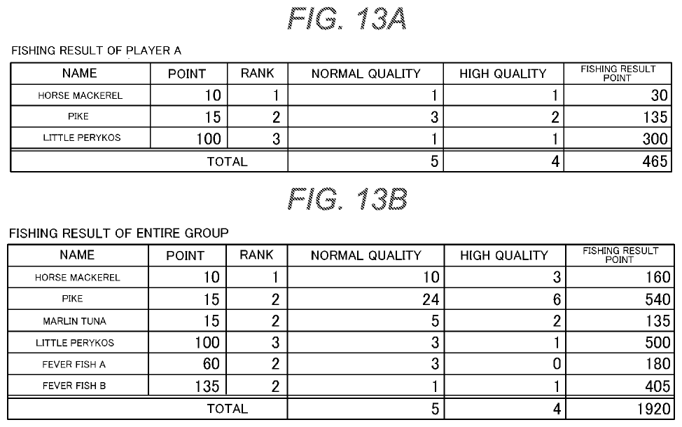

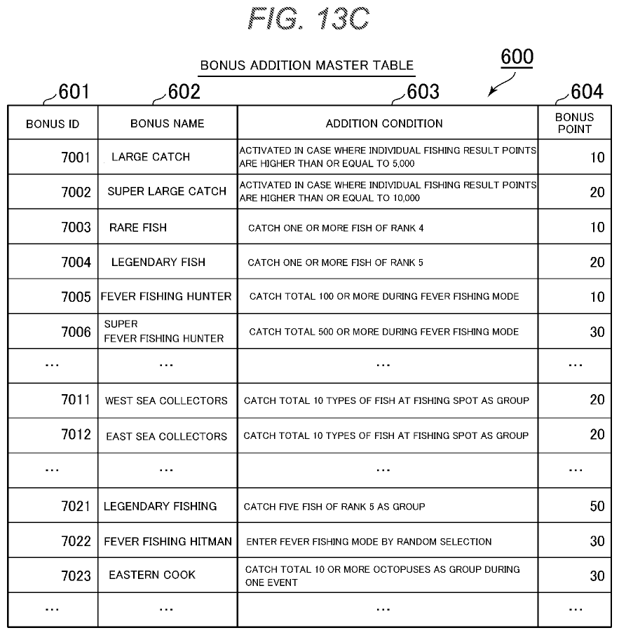

FIGS. 13A to 13C are diagrams for describing an evaluation result according to at least one embodiment of the present disclosure. FIG. 13A is a diagram illustrating a fishing result of a player A in a case where the event is finished. As illustrated, the player A catches five fish of normal quality and four fish of high quality in total, and total fishing result points are 465. This is an evaluation (base evaluation) as a base of an individual record.

Fish of high quality is fish that can be collected with a predetermined probability in a case of providing the object and for which double points of fish of normal quality are counted. A probability of providing an object of high quality may be changed in accordance with the pole with which the character is equipped, or a length of a time period of the fighting motion.

FIG. 13B is a diagram illustrating a fishing result of a group accompanying the player A in a case where the event is finished. An individual fishing result may be comparable with the fishing result of the entire group. In addition, rankings may be created in the group in accordance with the points.

FIG. 13C is a diagram illustrating a bonus addition master table according to at least one embodiment of the present disclosure. A bonus addition master table 600 stores a bonus name 602, an addition condition 603, and a bonus point 604 in association with a bonus ID 601.

The addition condition 603 may include a condition that can be achieved as the individual fishing result, and a condition that can be achieved by the entire group. By doing so, a game system of higher interest that can provide a sense of unity to the group, increase a sense of solidarity, and improve a sense of immersion in the event further than in a case of individual playing can be provided.

The bonus point 604 is used for calculating a final evaluation result in a case where the addition condition 603 is satisfied. Specifically, the evaluation result is calculated by Expression (1) below.

Final Fishing Result Points=Individual Fishing Result Points as Base×(100+Total Bonus Points)/100 (1)

Not only the bonus point 604 stored in the bonus addition master table 600 but also the bonus point 506 stored in the provided object master table 500 may be added to total bonus points. For example, the bonus point 506 may be set in a case where the object is an object of a high rarity value that is rarely provided. That is, for an object that may be provided in only a special event or the like, a bonus can be added by changing a value of the bonus point 506 without maintaining data of the bonus addition master table 600, and a load of data maintenance can be reduced. Alternatively, the bonus point 506 stored in the provided object master table 500 may be managed as a ratio and may be multiplied by the base evaluation.

In the bonus addition master table 600, a bonus of which the bonus point 604 is higher is employed in the bonus name 602 in which multiple bonus points may occur. For example, in a case where individual fishing result points are 15,000 for a “large catch” and a “super large catch”, the addition condition 603 of both of the “large catch” and the “super large catch” is satisfied. However, in this case, only bonus points of the “super large catch” are counted.

The flowchart will be referred to again. The server apparatus 1 provides a reward corresponding to the evaluation result to the player (step S216) and finishes the process. For example, the reward may be an experience value, an item, or other objects or points that can be advantageous for progressing the game.

While a plurality of player characters (including NPCs) participating in the event board the ship in the above example, the embodiment of the present disclosure is not limited thereto, and NPCs not participating in the event may accompany. For example, an NPC who is a tool seller selling the bait, or a sailor who provides hints on fishing may accompany.

While the server apparatus is used in the above example, the embodiment of the present disclosure is not limited thereto. For example, a distributed ledger that is used for blockchain technology may be used instead of the storage of the server apparatus.

While the fishing spot is not changed in one event in the above example, the fishing spot may be changed. For example, three stages may be passed through in one event, and a time limit may be set for each stage. In a case where the time limit is exceeded, a transition may be made to a subsequent stage.

While a limit is not set on switching to the fever fishing mode in the above example, a limit may be set. For example, a limit such that the fever fishing mode is performed once in one event, or a limit such that the fever fishing mode is performed once in each stage in a case where a plurality of stages are present in the event may be set.

While an example of boarding the ship is illustrated in the above example, the embodiment of the present disclosure is not limited thereto. For example, movement to a game space different from a world outside the event may be performed. In addition, an image that can only be viewed by participating in the event may be set to be viewable. For example, the image viewable in only the event is an image of a mountain at sunset, an image of a part of life of an animal or an enemy character such as a monster, or a sound of a festival of a tribe that cannot be seen in normal game playing by moving on the ship. By setting the image to be viewable in only the event, depth can be provided to the world of the game.

While the process is executed in the server apparatus in the above example, the embodiment of the present disclosure is not limited thereto. For example, design may be appropriately changed such that each terminal apparatus executes the process.

As one aspect of the fourth embodiment, a new program of higher interest can be provided.

As one aspect of the fourth embodiment, a new program of higher interest that motivates the player to satisfy the addition condition by adding the evaluation corresponding to the satisfied addition condition in a case where the addition condition is satisfied can be provided.

As one aspect of the fourth embodiment, a new program of higher interest that motivates the player to switch the mode by switching the mode of the stage and changing the provision probability of the object in a case where the predetermined switching condition is satisfied can be provided.

As one aspect of the fourth embodiment, by switching the mode based on a predetermined switching probability in a case where a predetermined object is provided to the character, a program of higher interest that motivates the player to enjoy more contents by providing the player with room for guessing which object is to be provided in order to switch the mode can be provided.

As one aspect of the fourth embodiment, by deciding the switching probability of the mode based on a factor such as the environment of the stage that does not depend on an attribute of the player or the player character, randomness in occurrence of mode switching is implemented, and interest of the player can be further increased without making the player bored.

As one aspect of the fourth embodiment, by changing to a predetermined environment in a case where the time limit of the event is exceeded, finish of the mode can be visually perceived, and an effect of helping the user understand a progress status of the event is achieved.

As one aspect of the fourth embodiment, by changing the provision probability of the object based on the attribute of the character, a program of higher interest that provides motivation for growing the character can be provided.

As one aspect of the fourth embodiment, by enabling participation in the event by satisfying the predetermined participation condition, motivation for prompting the player who desires to participate in the event to perform an action for satisfying the participation condition can be provided.

As one aspect of the fourth embodiment, by causing the character to execute an action different from an action performed in the normal mode in a case where the mode is switched, whether or not the current mode is switched can be visually recognized, and an effect of helping the user perceive the progress status of the event is achieved.

As one aspect of the fourth embodiment, by causing the character to execute, in a shorter time period, the action performed in the normal mode in a case where the mode is switched, the user can feel an advantage for switching the mode. The user can be motivated to switch the mode and can enjoy the contents longer.

In the fourth embodiment, each of the “terminal apparatus”, the “server apparatus”, the “group”, the “event”, the “provision probability”, the “evaluation”, and the “calculation” can employ the contents disclosed in the first embodiment as necessary. Each of the “attribute”, the “base evaluation”, the “addition condition”, and the “additional evaluation” can employ contents disclosed in the second embodiment as necessary. Each of the “stage” and the “mode” can employ contents disclosed in the third embodiment as necessary.

In the fourth embodiment, for example, the “attribute of the character” refers to a parameter, a skill, or equipment of the character and, more specifically, is illustrated by an item to be used for collection, a tool, an experience value, and a performance value of the character.

### Fifth Embodiment

A summary of a fifth embodiment of the present disclosure will be described. Hereinafter, a game system including one or more terminal apparatuses operated by a player and a server apparatus connectable to the terminal apparatus by communication will be illustratively described as the fourth embodiment.

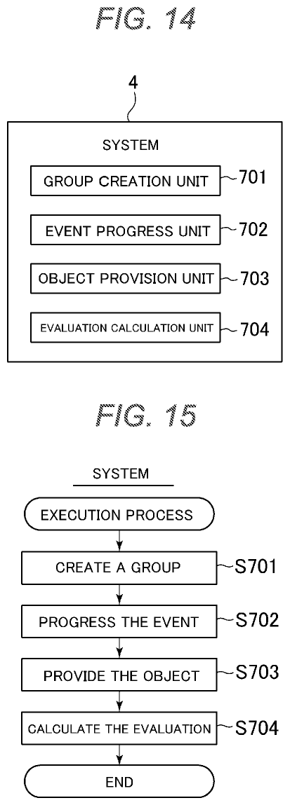

FIG. 14 is a block diagram illustrating a configuration of the system according to at least one embodiment of the present disclosure. A system 4 includes at least a group creation unit 701, an event progress unit 702, an object provision unit 703, and an evaluation calculation unit 704.

The group creation unit 701 has a function of creating a group that includes at least one character operated by the player. The event progress unit 702 has a function of progressing an event for each created group.

The object provision unit 703 has a function of providing an object to the character in the event based on a predetermined provision probability. The evaluation calculation unit 704 has a function of calculating an evaluation of the group in the event based on the object provided by the object provision unit 703.

Next, an execution process in the fifth embodiment of the present disclosure will be described. FIG. 15 is a flowchart of the execution process according to at least one embodiment of the present disclosure.

The system 4 creates the group including at least one character operated by the player (step S701). Next, the system 4 progresses the event for each created group (step S702). Next, the system 4 provides the object to the character in the event based on the predetermined provision probability (step S703). Next, the system 4 calculates the evaluation of the group in the event based on the provided object (step S704) and finishes the process.

As one aspect of the fifth embodiment, a new system of higher interest can be provided.

In the fifth embodiment, each of the “terminal apparatus”, the “server apparatus”, the “group”, the “event”, the “provision probability”, the “evaluation”, and the “calculation” can employ contents disclosed in the first embodiment as necessary.

### Sixth Embodiment

A summary of a sixth embodiment of the present disclosure will be described. Hereinafter, a game program that is executed in a computer apparatus operated by one or more player will be illustratively described as the sixth embodiment.

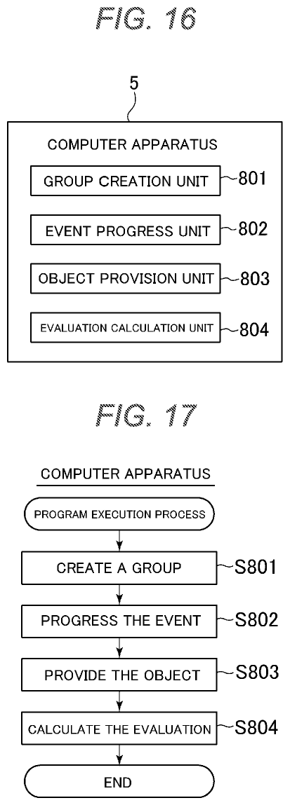

FIG. 16 is a block diagram illustrating a configuration of the computer apparatus according to at least one embodiment of the present disclosure. A computer apparatus 5 includes at least a group creation unit 801, an event progress unit 802, an object provision unit 803, and an evaluation calculation unit 804.

The group creation unit 801 has a function of creating a group that includes at least one character operated by the player. The event progress unit 802 has a function of progressing an event for each created group.

The object provision unit 803 has a function of providing an object to the character in the event based on a predetermined provision probability. The evaluation calculation unit 804 has a function of calculating an evaluation of the group in the event based on the object provided by the object provision unit 803.

Next, a program execution process in the sixth embodiment of the present disclosure will be described. FIG. 17 is a flowchart of the program execution process according to at least one embodiment of the present disclosure.

The computer apparatus 5 creates the group including at least one character operated by the player (step S801). Next, the computer apparatus 5 progresses the event for each created group (step S802). Next, the computer apparatus 5 provides the object to the character in the event based on the predetermined provision probability (step S803). Next, the computer apparatus 5 calculates the evaluation of the group in the event based on the provided object (step S804) and finishes the process.

As one aspect of the sixth embodiment, a new game program of higher interest can be provided.

In the sixth embodiment, each of the “terminal apparatus”, the “server apparatus”, the “group”, the “event”, the “provision probability”, the “evaluation”, and the “calculation” can employ contents disclosed in the first embodiment as necessary.

In a sixth embodiment, for example, a “computer apparatus” refers to a stationary game console, a portable game console, a wearable terminal, a desktop or laptop personal computer, a tablet computer, or a PDA and may be a portable terminal such as a smartphone that includes a touch panel sensor on a display screen.

### Seventh Embodiment

A summary of a seventh embodiment of the present disclosure will be described. Hereinafter, a program executed in a computer apparatus will be illustratively described as the seventh embodiment.

A summary of the program in the seventh embodiment can employ contents related to the summary of the system in the fourth embodiment as necessary. Furthermore, a participation process for an event can employ contents related to the participation process for the event in the fourth embodiment as necessary.

### Functional Description

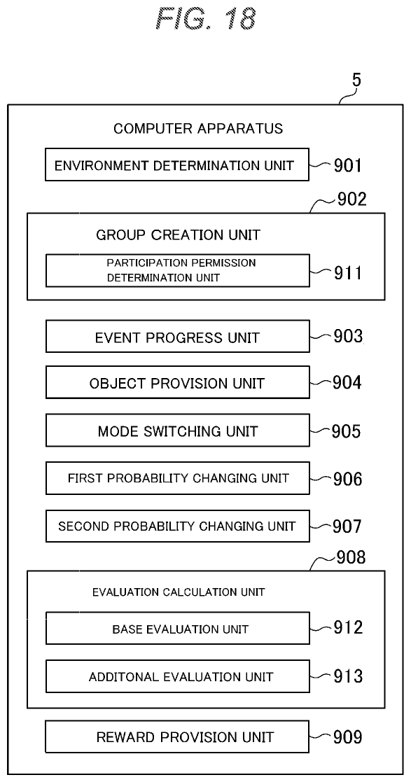

Next, a function of the computer apparatus in the seventh embodiment of the present disclosure will be described. FIG. 18 is a block diagram illustrating a configuration of the computer apparatus according to at least one embodiment of the present disclosure.

A computer apparatus 5 may include an environment determination unit 901, a group creation unit 902, an event progress unit 903, an object provision unit 904, a mode switching unit 905, a first probability changing unit 906, a second probability changing unit 907, an evaluation calculation unit 908, and a reward provision unit 909. The group creation unit 902 may include a participation permission determination unit 911. The evaluation calculation unit 908 may include a base evaluation unit 912 and an additional evaluation unit 913.

The environment determination unit 901 has a function of determining an environment of a stage included in the event based on a predetermined environment decision probability. The group creation unit 902 has a function of creating a group that includes at least one character operated by a player. The event progress unit 903 has a function of progressing the event for each created group.

The object provision unit 904 has a function of providing an object to the character in the event based on a predetermined provision probability. The mode switching unit 905 has a function of switching a mode of the stage in a case where a predetermined switching condition is satisfied.

The first probability changing unit 906 has a function of changing the predetermined provision probability for providing the object in a case where the mode is switched by the mode switching unit 905. The second probability changing unit 907 has a function of changing the predetermined provision probability based on an attribute of the character.

The evaluation calculation unit 908 has a function of calculating an evaluation of the group in the event based on the object provided by the object provision unit 904. The reward provision unit 909 has a function of providing a reward based on the evaluation calculated by the evaluation calculation unit 908.

The participation permission determination unit 911 has a function of determining permission of participation depending on whether or not a predetermined participation condition for participating in the event is satisfied. The base evaluation unit 912 has a function of deciding a base evaluation based on an attribute of the object. The additional evaluation unit 913 has a function of deciding an additional evaluation corresponding to a satisfied addition condition in a case where a predetermined addition condition is satisfied.

### Program Execution Process

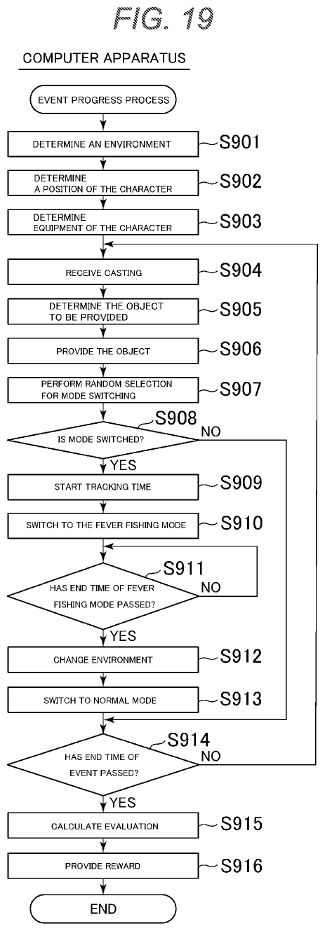

Next, an execution process in the seventh embodiment of the present disclosure will be described. FIG. 19 is a flowchart of a program execution process according to at least one embodiment of the present disclosure.

The computer apparatus 5 starts the event in a case where a time set in the computer apparatus 5 exceeds a predetermined event start time. The computer apparatus 5 decides an environment of the event by random selection (step S901). For example, the environment of the event is illustrated by weather (sun, cloud, rain, snow, thunderstorm, and storm), a state of sea, presence or absence of wind, and a wind speed. Day and night setting may be set in connection with the start time of the event or may be set without connection with the start time such that the time in the event is night even in a case where the event starts at 09:00 in the morning.

The provision probability of the object may be changed in accordance with the environment of the event. For example, the provision probability may be changed in accordance with the weather. In addition, depending on the weather, the probability of the object that can be caught may be changed, or a target that can be caught may be changed such that fish of a high grade is caught. By randomly deciding the weather by random selection, a game system of higher interest that prevents the user from perceiving the weather in which the event is started, and causes the user to feel excitement can be provided.

Next, the computer apparatus 5 decides a position of the character by an operation instruction from the user (step S902). As the position of the character, any location can be designated, or any of a plurality of predetermined positions may be selected.

Next, the computer apparatus 5 decides equipment of the character by the operation instruction from the user (step S903). For example, the equipment of the character refers to a pole, a bait, a reel, and a lure to be used for fishing.

Next, the computer apparatus 5 receives casting by the operation instruction from the user (step S904). After a predetermined time period elapses, the computer apparatus 5 decides the object to be provided to the user by random selection (step S905). The character may be caused to execute the fighting motion during a period from casting until provision of the object. A provided object master table in the seventh embodiment can employ contents of the provided object master table in FIGS. 11A to 11C and the fourth embodiment as necessary.

The computer apparatus 5 provides the object decided in step S905 to the character (step S906). Providing the object to the character includes associating the object with an account of the user (player) operating the character.

Next, the computer apparatus 5 executes random selection as to whether or not to switch the mode based on a mode switching probability associated with the object provided in step S906 (step S907).

In a case where mode switching is executed (YES in step S908), the computer apparatus 5 starts tracking time (step S909) and switches to a fever fishing mode (step S910). The fever fishing mode in the seventh embodiment can employ contents of the fever fishing mode in FIGS. 12A to 12C and the fourth embodiment as necessary.

A continuable time limit is set in advance in the fever fishing mode. The computer apparatus 5 determines whether or not an elapsed time period from a start of the fever fishing mode exceeds the time limit (step S911). In a case where the time limit is not exceeded (NO in step S911), the fever fishing mode is continued. In a case where the time limit is exceeded (YES in step S911), the fever fishing mode is finished, and the environment is changed such that the weather is set to sun (step S912). Furthermore, switching is performed to the normal mode (step S913).

Next, the computer apparatus 5 determines whether or not a finish time of the event has passed (step S914). In a case where the finish time has not passed (NO in step S914), fishing can be continued. In a case where the finish time of the event has passed (YES in step S914), the computer apparatus 5 calculates the evaluation (step S915). Calculation of the evaluation in the seventh embodiment can employ contents related to calculation of the evaluation in FIGS. 13A to 13C and the fourth embodiment as necessary.

In the event, a plurality of characters can play in parallel and may check a state of a fishing result with each other. By doing so, a game system of higher interest that can be enjoyed by both a player experienced in fishing and a so-called beginner player not experienced in fishing can be provided.

The computer apparatus 5 provides a reward corresponding to the evaluation result to the player (step S916) and finishes the process. For example, the reward may be an experience value, an item, or other objects or points that can be advantageous for progressing the game.

While a plurality of player characters (including NPCs) participating in the event board the ship in the above example, the embodiment of the present disclosure is not limited thereto, and NPCs not participating in the event may accompany. For example, an NPC who is a tool seller selling the bait, or a sailor who provides hints on fishing may accompany.

While the fishing spot is not changed in one event in the above example, the fishing spot may be changed. For example, three stages may be passed through in one event, and a time limit may be set for each stage. In a case where the time limit is exceeded, a transition may be made to a subsequent stage.

While a limit is not set on switching to the fever fishing mode in the above example, a limit may be set. For example, a limit such that the fever fishing mode is performed once in one event, or a limit such that the fever fishing mode is performed once in each stage in a case where a plurality of stages are present in the event may be set.

While an example of boarding the ship is illustrated in the above example, the embodiment of the present disclosure is not limited thereto. For example, movement to a game space different from a world outside the event may be performed. In addition, an image that can only be viewed by participating in the event may be set to be viewable. For example, the image viewable in only the event is an image of a mountain at sunset, an image of a part of life of an animal or an enemy character such as a monster, or a sound of a festival of a tribe that cannot be seen in normal game playing by moving on the ship. By setting the image to be viewable in only the event, depth can be provided to the world of the game.

As one aspect of the seventh embodiment, a new program of higher interest can be provided.

As one aspect of the seventh embodiment, a new program of higher interest that motivates the player to satisfy the addition condition by adding the evaluation corresponding to the satisfied addition condition in a case where the addition condition is satisfied can be provided.

As one aspect of the seventh embodiment, a new program of higher interest that motivates the player to switch the mode by switching the mode of the stage and changing the provision probability of the object in a case where the predetermined switching condition is satisfied can be provided.

As one aspect of the seventh embodiment, by switching the mode based on a predetermined switching probability in a case where a predetermined object is provided to the character, a program of higher interest that motivates the player to enjoy more contents by providing the player with room for guessing which object is to be provided in order to switch the mode can be provided.

As one aspect of the seventh embodiment, by deciding the switching probability of the mode based on a factor such as the environment of the stage that does not depend on an attribute of the player or the player character, randomness in occurrence of mode switching is implemented, and interest of the player can be further increased without making the player bored.

As one aspect of the seventh embodiment, by changing to a predetermined environment in a case where the time limit of the event is exceeded, finish of the mode can be visually perceived, and an effect of helping the user understand a progress status of the event is achieved.

As one aspect of the seventh embodiment, by changing the provision probability of the object based on the attribute of the character, a program of higher interest that provides motivation for growing the character can be provided.

As one aspect of the seventh embodiment, by enabling participation in the event by satisfying the predetermined participation condition, motivation for prompting the player who desires to participate in the event to perform an action for satisfying the participation condition can be provided.

As one aspect of the seventh embodiment, by causing the character to execute an action different from an action performed in the normal mode in a case where the mode is switched, whether or not the current mode is switched can be visually recognized, and an effect of helping the user perceive the progress status of the event is achieved.

As one aspect of the seventh embodiment, by causing the character to execute, in a shorter time period, the action performed in the normal mode in a case where the mode is switched, the user can feel an advantage for switching the mode. The user can be motivated to switch the mode and can enjoy the contents longer.

### Appendix

The above embodiments have been described such that the following disclosure can be embodied by those who have ordinary knowledge in the field to which the disclosure belongs.

(1) A game program executed in a server apparatus of a game system including one or more terminal apparatuses operated by a player and the server apparatus connectable to the terminal apparatus by communication, the game program causing the server apparatus to function as group creation means for creating a group including at least one character operated by the player, event progress means for progressing an event for each created group, object provision means for providing an object to the character in the event based on a predetermined provision probability, and evaluation calculation means for calculating an evaluation of the group in the event based on the provided object.

(2) The game program according to (1), in which the evaluation calculation means includes base evaluation means for deciding a base evaluation based on an attribute of the object, and additional evaluation means for deciding an additional evaluation corresponding to a satisfied addition condition in a case where a predetermined addition condition is satisfied, and the evaluation calculation means calculates the evaluation of the group based on the base evaluation and the additional evaluation.

(3) The game program according to (1) or (2), in which the event progress means progresses the event in one or more stages, and the game program further causes the server apparatus to function as mode switching means for switching a mode of the stage in a case where a predetermined switching condition is satisfied, and first probability changing means for changing the predetermined provision probability in a case where the mode is switched.

(4) The game program according to (3), in which in a case where a predetermined object is provided to the character, the mode switching means switches the mode based on a predetermined switching probability.

(5) The game program according to (4), further causing the server apparatus to function as environment determination means for determining an environment of the stage based on a predetermined environment decision probability, in which the predetermined switching probability is decided based on the determined environment.

(6) The game program according to [5], in which a time limit is set in the mode of the stage, and in a case where the time limit is exceeded, the environment is changed to a predetermined environment.

(7) The game program according to any one of (1) to (6), further causing the server apparatus to function as second probability changing means for changing the predetermined provision probability based on an attribute of the character.

(8) The game program according to any one of (1) to (7), in which the group creation means includes participation permission determination means for determining permission of participation depending on whether or not a predetermined participation condition for participating in the event is satisfied, and the predetermined participation condition is that the character has a predetermined attribute, and an operation instruction for a participation application from the player is received within a time range in which participation in the event is receivable.

(9) The game program according to any one of (3) to (8), in which in a case where the object is provided by the object provision means, the character provided with the object executes a predetermined action, and in a case where the mode is switched by the mode switching means, the predetermined action is changed.

(10) The game program according to any one of (3) to (9), in which in a case where the object is provided by the object provision means, the character provided with the object executes a predetermined action, and in a case where the mode is switched by the mode switching means, a time period for executing the predetermined action is set to be shorter than the time period before the mode is switched.

(11) The game program according to (2), in which the predetermined addition condition includes an individual condition satisfied by the character and a group condition satisfied by the group.

(12) A server apparatus on which the game program according to any one of (1) to (11) is installed.

(13) A game system including one or more terminal apparatuses operated by a player and a server apparatus connectable to the terminal apparatus by communication, the game system including group creation means for creating a group including at least one character operated by the player, event progress means for progressing an event for each created group, object provision means for providing an object to the character in the event based on a predetermined provision probability, and evaluation calculation means for calculating an evaluation of the group in the event based on the provided object.

(14) A game program executed in a terminal apparatus of a game system including one or more terminal apparatuses operated by a player and a server apparatus connectable to the terminal apparatus by communication, in which the server apparatus functions as group creation means for creating a group including at least one character operated by the player, event progress means for progressing an event for each created group, object provision means for providing an object to the character in the event based on a predetermined provision probability, and evaluation calculation means for calculating an evaluation of the group in the event based on the provided object, and the game program causes the terminal apparatus to function as operation reception means for receiving an operation instruction from the player, and display means for displaying a progress status of the event.

(15) A terminal apparatus on which the game program according to (14) is installed.

(16) A method for game control executed in a server apparatus of a game system including one or more terminal apparatuses operated by a player and the server apparatus connectable to the terminal apparatus by communication, the method including creating a group including at least one character operated by the player, progressing an event for each created group, providing an object to the character in the event based on a predetermined provision probability, and calculating an evaluation of the group in the event based on the provided object.

(17) A method for game control executed in a game system including one or more terminal apparatuses operated by a player and a server apparatus connectable to the terminal apparatus by communication, the method including creating a group including at least one character operated by the player, progressing an event for each created group, providing an object to the character in the event based on a predetermined provision probability, and calculating an evaluation of the group in the event based on the provided object.

(18) A game program executed in a computer apparatus operated by one or more players, the game program causing the computer apparatus to function as group creation means for creating a group including at least one character operated by the player, event progress means for progressing an event for each created group, object provision means for providing an object to the character in the event based on a predetermined provision probability, and evaluation calculation means for calculating an evaluation of the group in the event based on the provided object.

(19) A computer apparatus operated by one or more players, the computer apparatus including group creation means for creating a group including at least one character operated by the player, event progress means for progressing an event for each created group, object provision means for providing an object to the character in the event based on a predetermined provision probability, and evaluation calculation means for calculating an evaluation of the group in the event based on the provided object.

(20) A method for game control executed in a computer apparatus operated by one or more players, the method including creating a group including at least one character operated by the player, progressing an event for each created group, providing an object to the character in the event based on a predetermined provision probability, and calculating an evaluation of the group in the event based on the provided object.

### REFERENCE SIGNS LIST

1 SERVER APPARATUS

2 COMMUNICATION NETWORK

3 TERMINAL APPARATUS

4 SYSTEM

5 COMPUTER APPARATUS

500 PROVIDED OBJECT MASTER TABLE

600 BONUS ADDITION MASTER TABLE

1. A non-transitory computer-readable recording medium having recorded thereon a game program which is configured to be executed in a server apparatus of a game system including one or more terminal apparatuses operated by a player and the server apparatus configured to connect to the one or more terminal apparatuses by communication, the game program causing the server apparatus to perform functions comprising:
creating a group including at least one character operated by the player;
progressing an event for each created group;
providing an object to the at least one character in the event based on a predetermined provision probability used for determining whether or not to provide the object; and
calculating an evaluation of the group in the event based on the provided object.

2. The non-transitory computer-readable recording medium according to claim 1, wherein calculating the evaluation of the group comprises:
determining a base evaluation based on an attribute of the object; and
determining an additional evaluation corresponding to a satisfied condition for addition when a predetermined condition for the addition is satisfied; and
calculating the evaluation of the group based on the base evaluation and the additional evaluation.

3. The non-transitory computer-readable recording medium according to claim 1, wherein progressing the event is executed in one or more stages, and
wherein the functions further comprise:
switching a mode of the stage when a predetermined switching condition is satisfied, and
changing the predetermined provision probability when the mode is switched.

4. The non-transitory computer-readable recording medium according to claim 3, wherein switching the mode is based on a predetermined switching probability when a predetermined object is provided to the character.

5. The non-transitory computer-readable recording medium according to claim 4, wherein the functions further comprise:
determining an environment of the stage based on a predetermined environment decision probability,
wherein the predetermined switching probability is determined based on the determined environment.

6. The non-transitory computer-readable recording medium according to claim 5, wherein a time limit is set in the mode of the stage, and
wherein the environment is configured to change to a predetermined environment when the time limit is exceeded.

7. The non-transitory computer-readable recording medium according to claim 1, wherein the functions further comprise:
changing the predetermined provision probability based on an attribute of the character.

8. The non-transitory computer-readable recording medium according to claim 1, wherein creating the group comprises:
determining permission of participation depending on whether a predetermined participation condition for participating in the event is satisfied,
wherein the predetermined participation condition comprises:
the character has a predetermined attribute; and
an operation instruction for a participation application from the player is received within a time range while participation in the event is acceptable.

9. The non-transitory computer-readable recording medium according to claim 3, wherein the character provided with the object is configured to execute a predetermined action, if the object is provided, and
wherein the predetermined action is configured to change, if the mode is switched.

10. The non-transitory computer-readable recording medium according to claim 3, wherein the character provided with the object is configured to execute a predetermined action, if the object is provided, and
wherein a time period for executing the predetermined action is set to be shorter than the time period before the mode is switched if the mode is switched.

11. The non-transitory computer-readable recording medium according to claim 2, wherein the predetermined condition for addition comprises an individual condition satisfied by the character and a group condition satisfied by the group.

12. A game system comprising:
one or more terminal apparatuses configured to be operated by a player; and
a server apparatus configured to connect to the one or more terminal apparatuses by communication,
wherein the game system comprises one or more computers configured to perform functions comprising:
creating a group including at least one character operated by the player;
progressing an event for each created group;
providing an object to the at least one character in the event based on a predetermined provision probability used for determining whether or not to provide the object; and
calculating an evaluation of the group in the event based on the provided object.

13. A method for game control executed in a server apparatus of a game system, the method comprising:
connecting to one or more terminal apparatuses in the game system by communication;
creating a group including at least one character operated by the player;
progressing an event for each created group;
providing an object to the character in the event based on a predetermined provision probability used for determining whether or not to provide the object; and
calculating an evaluation of the group in the event based on the provided object.
